(19) United States
(12) Patent Application Publication
(10) Pub. No.: US 2005/0081656 A1
(43) Pub. Date: Apr. 21, 2005

(54) Force element for vehicle impact crash simulator

(75) Inventors: Byron J. Saari, Minneapolis, MN (US); F. Joseph Albright, Chanhassen, MN (US); Ross H. Leuer, Minnetonka, MN (US)

Correspondence Address: Steven M. Koehler;Westman, Champlin & Kelly, Suite 1600, 900 Second Avenue South, Minneapolis, MN, 55402-3319, US

(73) Assignee: MTS Systems Corporation, Eden Prairie, MN (US)

(21) Appl. No.: 10/897,572

(22) Filed: Jul. 23, 2004

Related U.S. Application Data
(60) Provisional application No. 60/489,422, filed on Jul. 23, 2003.

(51) Int. Cl. G01M 17/007; G01M 17/00; G01M 7/08

(52) U.S. Cl. 73/865.3; 73/866.4; 73/12.01

(57) ABSTRACT

Embodiments of a crash simulator sled assembly are disclosed. The crash simulator sled assembly can include a sled, an element movable relative to the sled, and a force element, such as a damper assembly or actuator assembly, coupled to the element. A second sled can also be connected to the element. The damper assembly can control relative movement of the element relative to the sled, while the actuator can develop force to replace force attributable to mass. This provides advantages for more efficient and effective test crash simulation and research.

### CROSS REFERENCE TO RELATED APPLICATION

The present application is based on and claims the benefit of U.S. provisional patent application Ser. No. 60/489,422, filed Jul. 23, 2003, the content of which is hereby incorporated by reference in its entirety.

### BACKGROUND OF THE INVENTION

The present invention relates generally to vehicle crash simulators.

A vehicle crash simulator simulates dynamics of a crash to evaluate vehicle occupant safety and conditions during a crash event. A crash simulator uses data from an actual test crash or computer simulation to physically simulate movement of a vehicle during a crash for evaluation. During a simulated crash, velocity is imparted by a velocity generator to a base sled carrying a specimen to simulate vehicle acceleration. Sensors and instruments on stationary mounts or on board the simulation apparatus or specimen collect test data for evaluation.

During a side impact crash, a “bullet car”, i.e. a moving car, strikes the door of an impacted/target car. Initially after contact from the bullet car, the impacted door of the target car accelerates in the direction that the bullet car was travelling. At the same time, the mass of and mechanical resistance from the impacted door begin to decelerate the bullet car. Consequently, the door initially accelerates up to some proportion of the pre-impact velocity of the bullet car, before the deformation of the impacted door translates into effective coupling of the mass of the entire target vehicle with the impacted door. Shortly after deformation of the impacted door and deformation of the front portion of the bullet car, the impacted door develops an effective mechanical coupling with the inertia or mass of the entire target car. The two cars then stop moving closer to each other as the combined body of both cars continues moving with a single momentum conforming to the initial momenta of the two cars according to conservation of momentum.

FIG. 1 graphically illustrates a velocity profile for the door, where at T₀ the velocity of the door is zero. The door then experiences a rapid increase in velocity to a maximum velocity V_{M}. Thereafter, as the inertia of the impacted vehicle is mechanically coupled to the door, the velocity of the door decreases, for example, to approximately half of its maximum velocity, if both cars have approximately the same mass.

FIG. 2 is a graph of the acceleration of the door. In view of the increase and subsequent decrease in velocity of the door as illustrated in FIG. 1, the door thus experiences first positive, and then negative, acceleration during the side impact crash.

Typically, the side impact crash is simulated with a previously deformed door fixed to the sled and a vehicle seat with a test dummy strapped thereto or disposed thereon. The seat rides upon a platform that can move freely on top of the sled, for example, riding on bearings, rollers or the like. A velocity generator (for example, a large actuator such as a hydraulic, pneumatic, or an electric actuator) applies force and thereby displacement of the sled in a direction that causes a test dummy and seat to impact the door. In particular, the velocity generator causes an increase in velocity and positive acceleration of the sled, while a braking device slows the sled down and thereby induces a negative acceleration.

Nevertheless, due to the relative velocity of the door and the test dummy/seat it is difficult to properly simulate region 14 (FIG. 1) using current test apparatuses and methods. The present invention addresses these and other aspects and provides solutions not previously recognized.

### SUMMARY OF THE INVENTION

Embodiments of a crash simulator sled assembly are disclosed. The crash simulator sled assembly can include a sled, an element movable relative to the sled, and a force element such as a damper assembly or actuator assembly coupled to the element. A second sled can also be connected to the element. The damper assembly can control relative movement of the element relative to the sled, while the actuator can develop force to replace force attributable to mass. This provides advantages for more efficient and effective test crash simulation and research.

Specifically, one embodiment of the present invention relates to a crash simulator sled assembly that includes a sled, an element movable relative to the sled; and a damper assembly. The damper assembly is to control relative movement of the element relative to the sled.

Another embodiment of the present invention relates to a crash simulator sled assembly that includes a first sled, a second sled, an element movable relative to the first sled, and a force element. The force element is to control relative movement of the element relative to the second sled. The force element comprises at least one of a damper assembly, an actuator assembly, or a braking device and a reaction member.

Another embodiment of the present invention relates to a crash simulator sled assembly that includes a first sled, a second sled, an element movable relative to the first sled; and a force element. The force element is to control relative movement of the element relative to the first sled. The force element comprises at least one of a damper assembly, an actuator assembly, or a braking device and a reaction member.

Another embodiment of the present invention relates to a crash simulator sled assembly that includes a first sled, a second sled, an element secured to the first sled, and a force element. The element is movable relative to the second sled. The force element is connected between the platform and the second sled, to control relative movement of the element relative to the second sled. The force element comprises at least one of a damper assembly, an actuator assembly, or a braking device and a reaction member.

Another embodiment of the present invention relates to a method for simulating a vehicle crash. The method includes accelerating a sled having an element coupled to it with a damper assembly. The method also includes controlling the damper assembly to control relative movement of the element relative to the sled.

### BRIEF DESCRIPTION OF THE DRAWINGS

FIG. 1 is a graphical representation of door velocity during a side impact vehicle crash.

FIG. 2 is a graphical representation of door acceleration during a side impact vehicle crash.

FIG. 3 is a schematic illustration of a first embodiment of a testing apparatus of the present invention.

FIG. 4 is a schematic illustration of a second embodiment of a testing apparatus of the present invention.

FIG. 5 is a schematic illustration of a third embodiment of a testing apparatus of the present invention.

FIG. 6 is a schematic illustration of an embodiment of one aspect of a testing apparatus of the present invention.

### DETAILED DESCRIPTION OF THE ILLUSTRATIVE EMBODIMENTS

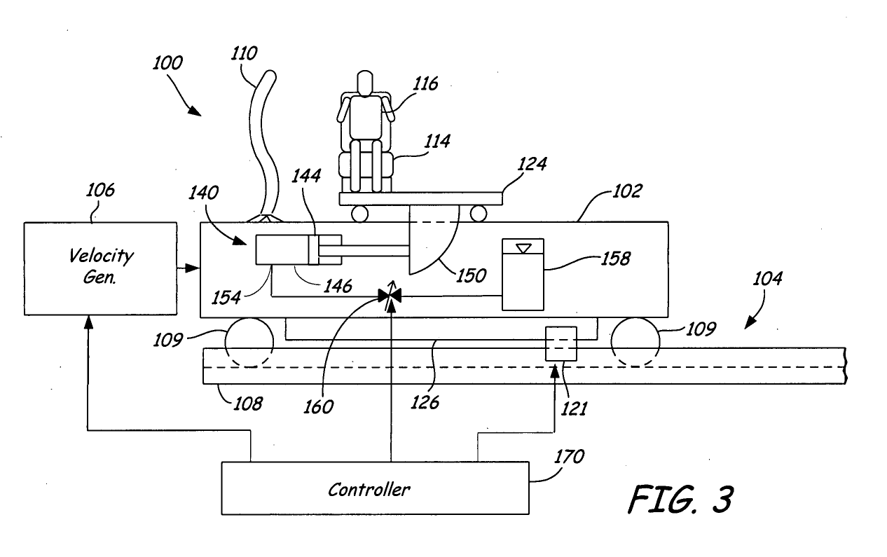

FIG. 3 illustrates an embodiment of a testing apparatus or a crash simulator 100 that simulates relative motion experienced between a target vehicle door and the vehicle to which it is attached. As illustrated in FIG. 3, the crash simulator 100 includes a base sled 102, which is movable, for example, being coupled to a track 104. As schematically shown, the sled 102 is moved along the track 104 via a velocity generator 106 to simulate crash accelerations. In the illustrated embodiment, the track 104 includes opposed rails 108, one of which is shown. The sled 102 is movably coupled along rails 108 via a bearing system illustrated schematically as wheels 109.

A door 110 is fixed to sled 102, while a vehicle seat 114 and test dummy 116 disposed thereon are coupled to a movable platform 124 that can move relative to sled 102 on suitable rollers or guide tracks coupled between platform 124 and sled 102. A braking device 121, such as a caliper, is operably coupled to a fin or rotor 126 to slow the sled 102 down. At this point it should be noted that the platform and the test specimen are substantially lighter than the sled. For example, the platform and test specimen can be on the order of one fourth the mass of the sled.

The velocity generator 106 engages sled 102 and accelerates the combined mass of the sled 102, the platform 124 and attached specimen. A damper assembly 140 is operably coupled between the sled 102 and the platform 124 to control the relative velocity between the sled 102 and the platform 124. Since the damper assembly 140 controls the motion of a much smaller mass than the mass of the sled 102, control of the motion of platform 124 relative to the sled is particularly accurate.

For example, in one embodiment, the relative movement of the platform 124 relative to sled 102, as controlled by damper assembly 140, has a precision that is proportional to a ratio of the mass of sled 102 to the mass of platform 124. This is considered to include the mass of the objects fixed thereto, such as seat 114 and crash test dummy 116, in this embodiment. As a particular example taken from one illustrative embodiment, the mass of sled 102 is about 1,300 pounds, while the mass of platform 124 is about 300 pounds, according to this embodiment. The added precision of which controlled damper assembly 140 is capable when coupled with this sort of mass ratio provides significant and novel advantages in the performance of such embodiments.

In one illustrative embodiment, the crash simulation can be considered in two phases, including acceleration and subsequent deceleration. First, velocity generator 106 accelerates sled 102 with door 110 mounted thereon, to simulate the initial phase of a crash of a bullet car into the door of a target car. Second, braking device 121 then decelerates sled 102 with door 110 mounted thereon, to simulate the coupling of the masses of the bullet car and the target car and consequent deceleration of the bullet car as it picks up the mass of the target car. During both phases, damper assembly 140 controls the relative velocity of platform 124 with seat 114 mounted thereon, with respect to sled 102 with door 110 mounted thereon. Damper assembly 140 is thereby configured to control relative movement of platform 124 relative to sled 102, independently of the deceleration of sled 102.

In the embodiment illustrated in FIG. 3, the damper assembly 140 includes a plunger 144 that can be a hydraulic, pneumatic or electrical device. Embodied as a hydraulic or pneumatic device, the plunger 144 is disposed in a cylinder 146, herein where the plunger 144 is operably coupled to the platform 124 via a gusset 150 and the cylinder 146 is fixed to the sled 102. An outlet 154 is coupled to a reservoir 158 through a valve mechanism 160 such as a servo valve, poppet valve, or other fluid control device. The valve mechanism 160 controls fluid flow from the cylinder 146, which in turn controls movement of the platform 124, seat 114 and test dummy 116 relative to the sled 102.

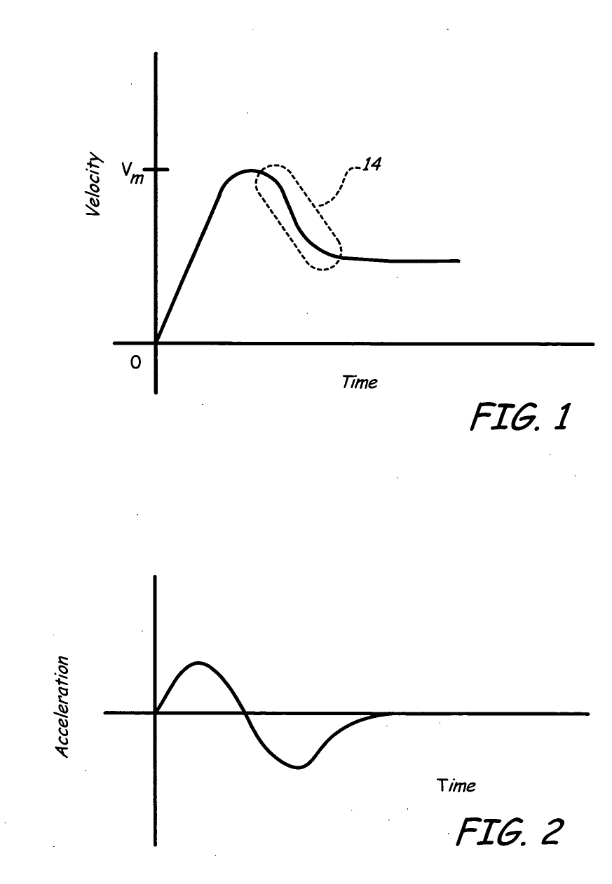

A controller 170 (analog, digital or combination thereof) provides control signals to velocity generator 106, valve mechanism 160 and braking device 121 so as to control the sled 102 through the velocity generator 106 and the braking device 121 as well as relative motion of the platform 124, seat 114 and test dummy 116 with respect to the door 110 via metering of the fluid through valve mechanism 160. In one embodiment, control of the valve mechanism 160 is through a predetermined profile stored in the controller 170, or through active feedback provided by suitable sensors such as accelerometers provided on the sled 102 and the platform 124, seat 114 or test dummy 116. In this manner, during the region 14 of FIG. 1, the damper assembly 140 controls relative motion of the platform 124, seat 114, and test dummy 116 relative to the sled 102, thus more accurately simulating interaction of the front portion of the bullet vehicle as it strikes and deforms with the door until the mass of the impacted vehicle is picked up.

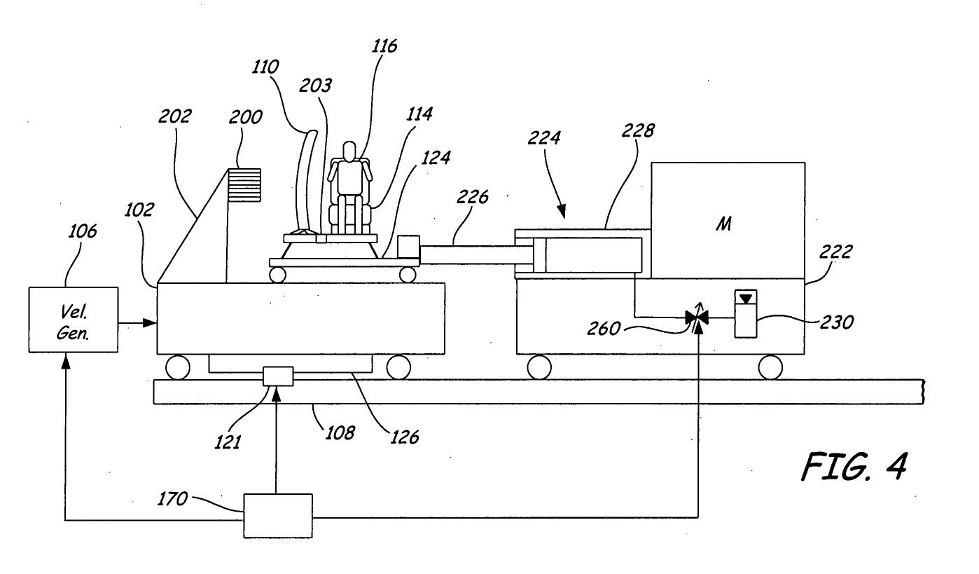

In the embodiment of FIG. 3, generally, the door is pre-deformed and fixed to the sled 102. Thus, this embodiment does not deform the door in real-time. FIG. 4 is a second embodiment of the present invention where deformation of the door occurs in real-time. In an embodiment of FIG. 4, sled 102 includes a crushable element 200 such as a honeycomb structure that simulates crushing of the front portion of the bullet car. The crushable element 200 is mounted to a support 202 of the sled 102. In this embodiment, the door 110 is mounted to the platform 124 along with the seat 114. A structural element 203 can couple the door 110 and the seat 114 together, in one embodiment. Structural element 203 may be an actual portion or segment of the vehicle's structure between door 110 and seat 114, or a crushable element that simulates this portion of the vehicle, in various embodiments. However, in a further embodiment, a damper assembly as illustrated in FIG. 3, can be used between the vehicle seat 114 and the door 110 as well. Additional types of force elements, such as an actuator assembly or a braking device with a corresponding reaction member, may also be used together with or instead of the damper assembly, in various embodiments corresponding to FIG. 4. Additional elements in FIG. 4 are analogous to identically labeled elements of FIG. 3, such as velocity generator 106, tracks 108, test dummy 116, braking device 121, fin 126, and controller 170.

In this embodiment, a second sled 222 is also coupled to tracks 108. Sled 222 is operably coupled to platform 124 with a damper assembly 224 of the type described above with respect to FIG. 3. In this embodiment, a fluid operated damper is provided wherein a plunger 226 is coupled to the platform 124, while a cylinder 228 is fixed to the second sled. A valve mechanism 260 controls fluid flow from the cylinder 228 to a reservoir 230. For instance, valve mechanism 260 can allow plunger 226 to move relative to the cylinder 228 during initial periods of the test to simulate sufficient deformation of the target and/or bullet car until a later point in time, when further movement of the plunger 226 relative to the cylinder 228 is disallowed, to simulate coupling of the two masses after deformation, at which point the first and second sleds 102, 222 travel together at the same velocity.

As appreciated by those skilled in the art, the location of the cylinder 228 and plunger 226 can be reversed as in the previous embodiment, if one desires. The damper assembly 224 allows the sled 102 to pick up the mass of the second sled 222 in a controlled manner so as to simulate how the bullet car picks up the mass of the target car.

The embodiment of FIG. 4 is a destructive test where crushable element 200, door 110 and possibly, structural element 203 (if an actual portion of the vehicle or a simulated portion of the vehicle is used) would have to be replaced for each test. It should also be noted that structural element 203 can be separate from platform 124 or a replaceable segment integrated or forming the platform 124. It should also be noted that the embodiment of FIG. 4 can also have sled 102 and platform 124 coupled together with a damper assembly 140 as illustrated in FIG. 3. This may be advantageous if it is desirable or necessary to carry some of the load through a second load path besides just structural element 203. In this manner, the second load path simulates the fact that an actual door includes hinges and a lock connected to the vehicle frame which would carry some of the load.

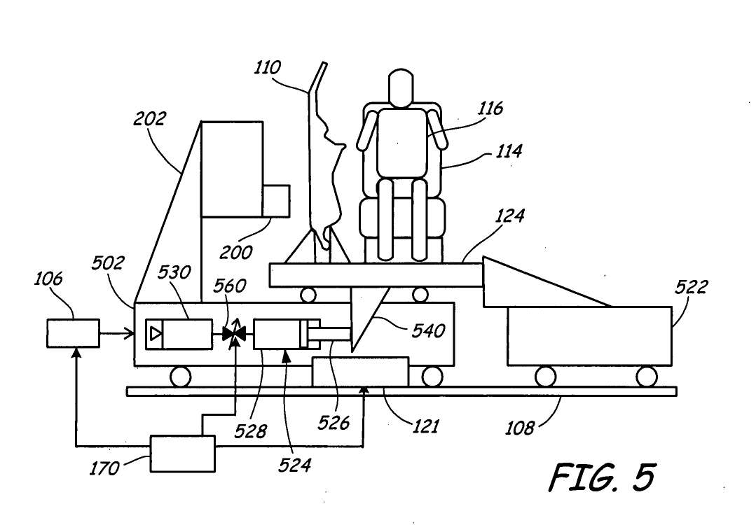

FIG. 5 is a third embodiment of the present invention, where deformation of the door occurs in real-time, similarly to the embodiment of FIG. 4. In an embodiment of FIG. 5, many components are similar in structure and function to the embodiment of FIG. 4 as described above. These include crushable element 200, support 202, door 110, platform 124, seat 114, tracks 108, velocity generator 106, controller 170, braking device 121, and test dummy 116.

In this embodiment, sleds 502 and 522 are coupled to tracks 108. Platform 124 is securely coupled to sled 522, and is operably coupled to sled 502 with a damper assembly 524 similar to the type described above with respect to FIG. 3. In this embodiment, damper assembly 524 is provided wherein a plunger 526 is coupled to the platform 124 via gusset 540, while a cylinder 528 is fixed to the first sled 502. A valve mechanism 560 controls fluid flow from the cylinder 528 to a reservoir 530. As appreciated by those skilled in the art, the location of cylinder 528 and plunger 526 can be reversed as in the previous embodiment, if one desires. This configuration allows platform 124 to be coupled securely to the mass of the second sled 522 to simulate enough of the mass of a vehicle immediately on impact to deform the door, while the damper assembly 524 allows the first sled 502 to pick up the additional mass of the second sled 522 in a controlled manner so as to simulate how the bullet car picks up the mass of the target car.

As with FIG. 4, additional types of force elements, such as an actuator assembly or a braking device with a corresponding reaction member, may also be used together with or instead of the damper assembly, in various embodiments corresponding to FIG. 5. Also as in FIG. 4, a controlled function of the damper assembly may be applied in one embodiment, in which the damper assembly simulates initial deformation by allowing relative motion of the bullet and target masses relative to each other, and is subsequently ramped up to an immobile state to disallow further relative motion between the bullet and target masses, to simulate the two masses becoming coupled together.

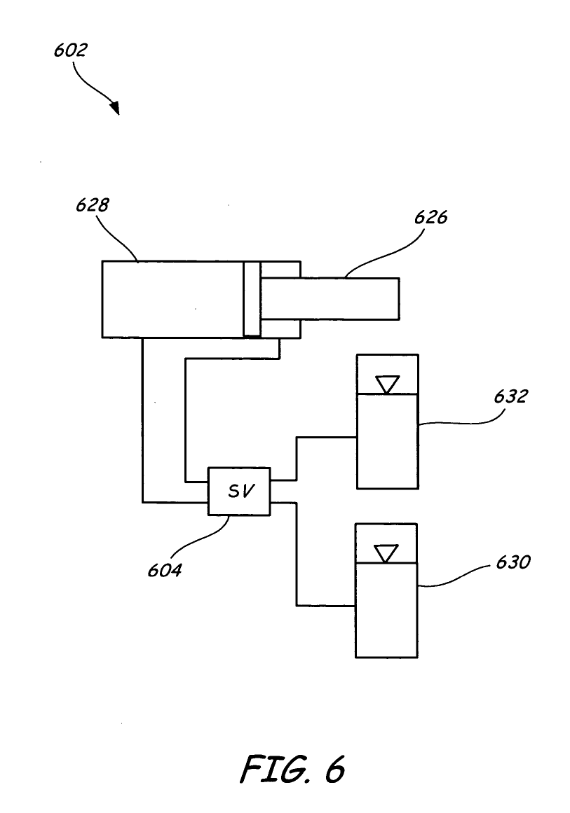

FIG. 6 illustrates an actuator assembly 602 that can be used as an alternative type of force element, or in addition, to the damper assemblies, previously described. Actuator assembly 602 also includes a cylinder 628, a plunger 626, a reservoir 630, and a reservoir 632. Actuator assembly 602 also includes servo valve 604 operably coupled between reservoir 630 and reservoir 632 on one side, and cylinder 628 and plunger 626 on the other side. Reservoir 630 is fluidly connected through servo valve 604 to the extension side of plunger 626 within cylinder 628, while reservoir 632 is fluidly connected through servo valve 604 to the retraction side of plunger 626 within cylinder 628, to drive extension and retraction respectively of plunger 626, as is well understood in the art. Although the components may seem similar to that of the damper assemblies, the actuator assembly functions as an actuator rather than a damper. In particular, the force developed by actuator assembly 602 may thereby take the place of some of the force of inertia due to the target mass, for example in the embodiments of FIGS. 4 and 5. Actuator assembly 602 thereby offers special advantages in some applications, such as allowing a sled mass coupled to a platform to be reduced, while maintaining the same experimental effect, thereby offering greater simplicity and affordability in some test crash applications, for example.

Suitable instrumentation of the sled(s), platform, test dummy, etc. (e.g. velocity, acceleration) can be obtained and recorded in order to provide data for computer simulation on the side impact crash test. Such simulation in a virtual world may be particularly advantageous in order to reduce the number of iterations of actual testing in order to generate the proper control profiles for the velocity generator 106 and the valve mechanism(s) used in each of the embodiments described above. By using computer simulation, less structural components would be used in order to obtain the proper profiles for the side impact test.

While the present invention has been described with reference to preferred embodiments, one skilled in the art will recognize that changes may be made in form or detail without departing from the spirit and scope of the invention. For example, a wide variety of different force elements may be used, such as a damper assembly providing resistance through interacting magnetic fields, in addition or in the alternative to the fluid operated plunger illustrated in FIGS. 3, 4 or 5. In such an embodiment, resistance can be controlled by varying the intensity of one or more of the interacting magnetic fields, and/or controlling current generated by such interaction. Similarly, the force element may include an actuator assembly taking other forms such as electric or magnetic actuators, in addition to or besides the hydraulic or pneumatic actuator illustrated in FIG. 6.

In yet a further embodiment, the damper assembly or actuator assembly can be replaced by a mechanical or hydro-mechanical braking device together with a corresponding reaction member, similar to braking device 121 and fin 126, for example. Furthermore, although illustrated for side impact crash simulation, those skilled in the art can appreciate that other forms of crash simulation, involving or requiring control of relative velocity of one or more components is also possible using the invention described herein.

1. A crash simulator sled assembly, comprising:
a rail;
a sled disposed movably on the rail;
a velocity generator for engaging the sled;
an element disposed on the sled and movable relative to the sled; and
a damper assembly to control relative movement of the element relative to the sled.

2. The crash simulator sled assembly of claim 1, wherein the element has a mass, and the sled has a mass that is greater than the mass of the element.

3. The crash simulator sled assembly of claim 2, wherein the relative movement of the element relative to the sled, as controlled by the damper assembly, has a precision that is based on a ratio of the mass of the sled to the mass of the element.

4. The crash simulator sled assembly of claim 1, further comprising a braking device for decelerating the sled, while the damper assembly is configured to control relative movement of the element relative to the sled, independently of the decelerating of the sled.

5. The crash simulator sled assembly of claim 1 wherein the element comprises a platform for holding a test specimen.

6. The crash simulator sled assembly of claim 1 wherein the damper assembly comprises a fluid plunger and a valve mechanism for controlling fluid flow to or from the fluid plunger.

7. The crash simulator sled assembly of claim 1 wherein the damper assembly is electric.

8. The crash simulator sled assembly of claim 1 wherein the damper assembly is magnetic.

9. The crash simulator sled assembly of claim 1 wherein the damper assembly is hydraulic.

10. The crash simulator sled assembly of claim 1 wherein the damper assembly is pneumatic.

11. The crash simulator sled assembly of claim 1 and further comprising a controller for controlling the velocity generator.

12. The crash simulator sled assembly of claim 1 and further comprising a controller for controlling the damper assembly.

13. The crash simulator of claim 1 wherein the element comprises a second sled.

14. A crash simulator sled assembly, comprising:
a first sled;
a second sled;
an element movable relative to the first sled; and
a force element to control relative movement of the element relative to the second sled, wherein the force element comprises at least one of a damper assembly, an actuator assembly, or a braking device and a reaction member.

15. The crash simulator sled assembly of claim 14 wherein the element comprises a platform for holding a test specimen.

16. The crash simulator sled assembly of claim 14 wherein the force element comprises a damper assembly or an actuator comprising a fluid plunger and a valve mechanism for controlling fluid flow to or from the fluid plunger.

17. The crash simulator sled assembly of claim 14 wherein the force element is electric.

18. The crash simulator sled assembly of claim 14 wherein the force element is magnetic.

19. The crash simulator sled assembly of claim 14 wherein the force element is hydraulic.

20. The crash simulator sled assembly of claim 14 wherein the force element is pneumatic.

21. The crash simulator sled assembly of claim 14 and further comprising a velocity generator for displacing the sled.

22. The crash simulator sled assembly of claim 21 and further comprising a controller for controlling the velocity generator.

23. The crash simulator sled assembly of claim 14 and further comprising a controller for controlling the force element.

24. A crash simulator sled assembly, comprising:
a first sled;
a second sled;
an element movable relative to the first sled; and
a force element to control relative movement of the element relative to the first sled, wherein the force element comprises at least one of a damper assembly, an actuator assembly, or a braking device and a reaction member.

25. The crash simulator sled assembly of claim 24 wherein the element comprises a platform for holding a test specimen.

26. The crash simulator sled assembly of claim 24 wherein the force element comprises a damper assembly or an actuator that comprises a fluid plunger and a valve mechanism for controlling fluid flow to or from the fluid plunger.

27. The crash simulator sled assembly of claim 24 wherein the force element is electric.

28. The crash simulator sled assembly of claim 24 wherein the force element is magnetic.

29. The crash simulator sled assembly of claim 24 wherein the force element is hydraulic.

30. The crash simulator sled assembly of claim 24 wherein the force element is pneumatic.

31. The crash simulator sled assembly of claim 24 and further comprising a velocity generator for displacing the sled.

32. The crash simulator sled assembly of claim 31 and further comprising a controller for controlling the velocity generator.

33. The crash simulator sled assembly of claim 24 and further comprising a controller for controlling the force element.

34. A crash simulator sled assembly, comprising:
a first sled;
a second sled;
an element secured to the first sled, and movable relative to the second sled; and
a force element connected between the element and the second sled, to control relative movement of the element relative to the second sled, wherein the force element comprises at least one of a damper assembly, an actuator assembly, or a braking device and a reaction member.

35. The crash simulator sled assembly of claim 34 wherein the force element comprises a damper assembly or an actuator assembly that comprises a fluid plunger and a valve mechanism for controlling fluid flow to or from the fluid plunger.

36. The crash simulator sled assembly of claim 34 and further comprising a velocity generator for displacing at least one of the first sled and the second sled.

37. The crash simulator sled assembly of claim 36 and further comprising a controller for controlling the velocity generator.

38. The crash simulator sled assembly of claim 34 and further comprising a controller for controlling the force element.

39. The crash simulator sled assembly of claim 34 wherein the force element is electric.

40. The crash simulator sled assembly of claim 34 wherein the force element is magnetic.

41. The crash simulator sled assembly of claim 34 wherein the force element is hydraulic.

42. The crash simulator sled assembly of claim 34 wherein the force element is pneumatic.

43. A method for simulating a vehicle crash comprising:
accelerating a sled having an element coupled to it with a damper assembly; and
controlling the damper assembly to control relative movement of the element relative to the sled.

44. The method of claim 43 and further comprising:
simulating movement of the element and the sled in a computer.

45. The method of claim 44 and further comprising:
collecting data with respect to movement of the element and the sled.
